(19) United States
(12) Patent Application Publication
(10) Pub. No.: US 2013/0260788 A1
(43) Pub. Date: Oct. 3, 2013

(54) DETERMINING A TRAVEL TIME OF AN ENTITY

(71) Applicants: Thomas Bonde, Copenhagen NV (DK); Lars Paulsen, San Jose, CA (US)

(72) Inventors: Thomas Bonde, Copenhagen NV (DK); Lars Paulsen, San Jose, CA (US)

(21) Appl. No.: 13/805,912

(22) PCT Filed: Jun. 20, 2011
(86) PCT No.: PCT/DK2011/050222

§ 371 Date: Jun. 6, 2013

Related U.S. Application Data
(60) Provisional application No. 61/360,945, filed on Jul. 2, 2010.

(30) Foreign Application Priority Data
Jun. 21, 2010 (DK) PA 2010 00543

(51) Int. Cl. H04W 4/02

(52) U.S. Cl. CPC H04W 4/025
USPC 455/456.1

(57) ABSTRACT

System and method for determining travel or dwell times of entities such as people, animals, vehicles, boats, and airplanes. A start and end time are determined based on measurements from one or more receivers measuring signals emitted by a transmitter transported by the entity. The invention also provides a computer system for determining a travel time based on measurements of signals from the transmitter.

### FIELD OF THE INVENTION

System and method for determining travel or dwell times of entities such as people, animals, vehicles, boats, and airplanes. A start and end time are determined based on measurements from one or more receivers measuring signals emitted by a transmitter transported by the entity. The invention also provides a computer system for determining a travel time based on measurements of signals from the transmitter.

### BACKGROUND OF THE INVENTION

Measuring the queue time of moving objects in a queue is done under many different circumstances. For example, the queue length of people waiting to be security-checked, to purchase goods or to be otherwise serviced. As a more specific example, airports perform queue time measurements at security check points in order to determine the need for opening more security check point lanes and will do so if the queue time exceeds a predetermined service level. This service level is often agreed between the airport and its commercially associated airliners to ensure that the airliners can provide scheduled flights on time. Other examples could be queue monitoring of entrances to amusement parks, ski lifts, cashier check-outs, or monitoring traffic queues and flows on highways etc. Keeping queues short also helps avoid losing customers due to the waiting time frustrations, and for airports especially, it increases the time passengers can spend in the tax free area, which has direct effect on tax free sale revenue.

Measuring the queue time of people waiting in lines becomes even more important when one considers broader uses of such information. On a long-term basis, queues performance data can be used to identify periods of higher and lower activity, in order to more effectively forecast the number of employees needed to handle the anticipated traffic volume. The information could also be used for comparing different stores/airports performances.

The queue time could furthermore optionally be augmented with data from a counting system, counting the number of people or objects entering and exiting the queue within a configurable time period. This optional data can assist to further detail average time per object being “processed” in live queue times forecasts.

Manual measurement and counting of moving queues objects is inaccurate and resource intensive. Nevertheless, these measurements of process times and counts of moving objects have traditionally been done manually by dedicated people using stopwatches.

Some systems for tracking and monitoring objects have been based on triangulating the radio frequencies (RF) signal strength levels, a calculated Time Of Arrival (TOA). Some systems can, in addition, determine the Angle Of Arrival (AOA). The radio frequency (RF) signals are normally generated by a custom device specially designed for the system which is attached to or carried by the object being tracked. Other systems rely on radio frequency enabled consumer devices such as cell phones. Cell phones can be tracked by detecting the Global System for Mobile communications (GSM) control commands continuously being sent from the phone to the radio tower and then triangulate the time of arrival (TOA) between three or more radio frequency receivers surrounding the area. However, the time between GSM control signals sent from the customer device and the radio tower can vary, making the tracking inaccurate. An example of a system using a derived version of the widely used time of arrival (TOA) method for positioning of a moving object carrying a RF device is described in US patent Application Publication US2006/0061469 A1.

### SUMMARY OF THE INVENTION

The present invention enables measuring travel time of an entity (person, animal or object) in a queue. It is based on measurements of signals received from a transmitter, such as a radio frequency (RF) transceiver, attached to or carried by the entity.

In a first aspect, the invention provides a method of determining a travel time of such an entity. The method comprises:
determining a start time based on a first set of measurements of signals emitted by a radio transmitter transported by the entity, the first set of measurements being obtained with a first signal receiver positioned at a first location;
determining an end time based on a second set of measurements of signals emitted by the radio transmitter, the second set of measurements being obtained with a second signal receiver positioned at a second location;
determining the travel time based on a difference between the start time and the end time.

The travel time thus determined represents a time it takes the entity to move from a vicinity of the first receiver (where the transmitter is close enough to the first receiver to allow the first receiver to obtain the first set of measurements) to a vicinity of the second receiver (where the transmitter is close enough to the second receiver to allow the second receiver to obtain the second set of measurements).

The start time is advantageously determined as a time at which the first receiver first detects a signal from the transmitter. Due to noise, a receiver requires a signal with a certain power in order to be able to detect it. When the transmitter is close enough to the receiver, the received power is sufficiently high compared to the receiver noise, and the receiver can detect the transmitter signal. Alternatively, the start time is a time at which the first receiver first obtains a transmitter identity from the transmitter. When the transmitter and receiver communicate for instance using the Bluetooth protocol, the receiver, which is then a Bluetooth transceiver, can communicate with the transmitter—also a Bluetooth transceiver—and obtain an identity of the transmitter. In the Bluetooth protocol, communication occurs between two transceivers that each has a fixed 48 bit unique device address (BD_ADDR). An identity can also be in the form of a transmitter-specific signal frequency or an encoding in the signal, for example a simple Morse encoding known for instance from non-directional beacons (NDB) used in aviation navigation. A person skilled in the art will recognize that many other types of encoding can be used.

The term “first detects a signal” refers to a situation in which the given receiver has not been able to detect a signal from the transmitter for some time. Such a time can be adapted to a given situation. For instance, it could mean that the first receiver has not been able to detect a signal from the transmitter for a predefined time (time window) or a time window provided to fit the circumstances. The time window might be 30 seconds or 1 minute or 2 minutes or 5 minutes or some other time window. A person skilled in the art will recognize that the time window can have any finite length and that such a time window might in some cases advantageously be adjusted in dependence on a typical travel time corresponding to a distance between the first location and the second location. The same applies to the term “first obtains a transmitter identity”. The time window can be adjusted as desired. These considerations apply also for the other aspects of the invention.

A start time can alternatively be a time at which the first receiver can no longer detect a signal from the transmitter. A start time can alternatively be a time at which the first receiver can no longer obtain such a transmitter identity from the transmitter. Similarly to the discussion relating to “first detects a signal” and “first obtains a transmitter identity”, the term “can no longer detect a signal” and “can no longer obtain such a transmitter identity” refer to situations in which the receiver has not, in a time window, been able to detect a signal or obtain the identity. The time window might be similar to that used in relation to “first detects a signal” or to that used in relation to “first obtains a transmitter identity”. Examples include 30 seconds or 1 minute or 2 minutes or 5 minutes. Again, a person skilled in the art will recognize that the time window can have any finite length and that such a time window might in some cases advantageously be adjusted in dependence on a typical travel time corresponding to a distance between the first location and the second location. These considerations apply also for the other aspects of the invention.

The end time can be determined similarly, based on the measurements from the second receiver. For instance, an end time could be a time at which the second receiver first receives a signal from the transmitter, or first obtains the transmitter's identity, or when it can no longer obtain a transmitter identity from the transmitter, or when it can no longer detect the signal from the transmitter.

In another embodiment, the start time is a time corresponding to a peak value within the first set of measurements.

The first receiver might be located where persons enter a queue, and the second receiver might be located where these persons exit the queue. The transmitter and receivers advantageously communicate using for example the Bluetooth protocol. With this protocol, the method can give results that are precise within seconds. Other RF technologies such as RFID or Zigbee can produce similar results. Additional RF transceivers may be installed at strategic positions to measure different processes in the queue in a specific monitored area. A system can be made to store historical process times, live process times or forecasted process time that represents the time that an entity is predicted to use in a given process. Acquiring information on how many objects enter the queue can be used to forecast the queue time for each object as the object enters the queue and can therefore be used to immediately better allocate the right resources to maintain a high service level in any situation while minimizing overstaffing waist.

The invention can also be used to measure the dwell time in a first area, such as to determine a time a customer spends in a mall, train station etc. This can be done by using one or more signal receivers at the entry and exit to determine when the customer arrives and departs from the monitored area. Accordingly, in a second aspect, the invention provides a method for determining a dwell time of an entity within a first area. The method comprises:
determining a start time based on a first set of measurements of signals emitted by a radio transmitter transported by the entity, the first set of measurements being obtained with a first signal receiver positioned at a first location;
determining an end time based on a second set of measurements of signals emitted by the radio transmitter, the second set of measurements being obtained with the first signal receiver or with a second signal receiver positioned at a second location;
determining the dwell time based on a difference between the start time and the end time;

The sets of measurements from the receivers are used for determining a start time and an end time and a difference between the start time and the end time as described in relation to the first aspect of the invention.

Again, the transmitter might be a transceiver.

The start time could be a time at which the first receiver first detects a signal from the transmitter, or it could be a time at which the first receiver first obtains a transmitter identity from the transmitter.

The end time could be a time at which the first receiver can no longer detect a signal from the transmitter, or it could be a time at which the first receiver can no longer obtain a transmitter identity from the transmitter.

In some embodiments that use a second receiver positioned at a second location, the method may comprise detecting a presence of the entity in a vicinity of the second location. In such embodiments, the second signal receiver is used to sort entities, often persons, according to whether they have been present in the vicinity of the second receiver, or not. If the second location is properly located inside a store, signals from transmitters carried by customers inside the store will be received by the second signal receiver, whereas signals from transmitters carried by non-customers—people who do not enter the store—will not (ideally). This makes it possible to discard—for the purpose of determining a true dwell time—first and second measurements that do not belong to customers.

The term “in a vicinity” is used because it represents the relationship between power transmitted by the transmitter and power received by the second signal receiver. The further the transmitter is from the second signal receiver, the lower the received power at the signal receivers will be. When the second signal receiver is an RF transceiver, it is possible to adjust the emitted power and thereby quite precisely adjust the distance at which the transmitter, when also having receiver capability, can interpret the signal from the RF transceiver and provide a return signal in response thereto. A vicinity may be 1 m, 2 m, 3 m, 4 m, 5 m, and so on, as desired or required, can become effective via an adjustment of the power transmitted by the second receiver. Due to environmental differences, transceiver properties and so on, it is not possible to provide corresponding absolute power figures, thus the functional definition of “in a vicinity”. In a concrete case, a technician will make the power adjustment to implement the “vicinity”. A person skilled in the art will also readily see that the figures 1 m, 2 m etc. are examples, and that any value above 0 m can be used and realized via a power adjustment (up to the power limit of the second receiver). Note also that the power emitted from the second receiver is rarely the same at all points having a given distance from the second receiver. A person or object positioned between the second receiver and the transmitter will absorb the signal. These considerations are described to ensure that the scope of the appended claims is interpreted fairly in favor of the patentee. Also, a person skilled in the art is well aware of how, say Bluetooth, can be used for this purpose and how the equipment shall be adjusted to realize the desired vicinity, i.e. the area in which the transmitter and the second receiver can communicate in accordance with the Bluetooth protocol.

A third aspect of the invention provides a computer system that is configured to:
receive a first set of measurements representing signals emitted by a radio transmitter transported by an entity, and determining a start time based on the first set of measurements;
receive a second set of measurements representing signals emitted by a radio transmitter transported by the entity, and determining an end time based on the second set of measurements;
determining a difference between the end time and the start time.

The first and second sets of measurements can be obtained with a first signal receiver, or the first set of measurements can be obtained with a first signal receiver and the second set of measurements be obtained with a second signal receiver.

The sets of measurements from the receivers are used for determining a start time and an end time and a difference between the start time and the end time as described in relation to the first aspect of the invention. For determining a dwell time, the computer system can also be configured to verify that a signal from the transmitter has been received by the second signal receiver.

Another aspect of the invention provides a system for determining a travel time. The system comprises:
first receiver positioned at a first location for receiving a first set of measurements representing signals emitted by a radio transmitter transported by an entity;
second receiver positioned at a second location for receiving a second set of measurements representing signals emitted by a radio transmitter transported by the entity;
computing means for determining a start time based on the first set of measurements, an end time based on the second set of measurements, and a difference between the end time and the start time.

The determined difference is a travel time.

The computing means can be a personal computer or other computing system, or it could be dedicated hardware, such as an application-specific integrated circuit (ASIC). The receivers are receivers adapted to receive electromagnetic radiation and provide an electric signal representing a magnitude (i.e. power) of the received electromagnetic radiation.

The times may for instance be determined as described in relation to the first aspect of the invention.

Another aspect of the invention provides a system for determining a dwell time in a vicinity of a first location. The system comprises:
first receiver positioned at the first location for receiving a first and second set of measurements representing signals emitted by a radio transmitter transported by an entity;
computing means for determining a start time based on the first set of measurements, an end time based on the second set of measurements, and a difference between the end time and the start time.

The determined difference is a dwell time.

The times may for instance be determined as described in relation to the second aspect of the invention.

Another aspect provides computer program for enabling appropriate computer hardware to act as the computer system described as the third aspect of the invention, or to act as the computing means described above. Another aspect provides a computer program product holding such a computer program.

### BRIEF DESCRIPTION OF THE DRAWINGS

FIG. 1 illustrates components for dwell time measurement and optional count acquisition, which are a Mobile RF Device (1), a RF Transceiver Device (2), an optional Counter Device (3) and a Data Processing Server (4).

FIG. 2 illustrates the components for travel time or dwell time determination, and optional count acquisition; the components which are a Mobile RF Device (1), two RF Transceiver Devices (2a, 2b) an optional Counter Device (3) and a Data Processing Server (4).

FIG. 3 illustrates use of the invention at a security check point in an airport, illustrating persons carrying Mobile RF Devices (1a, 1b), and typical positions for RF Transceiver Devices (2a,2b,2c), Counter Devices (3a, 3b) and connections to a Data Processing Server (4) and a Data Presentation Client (5).

FIG. 4 illustrates events associated with signals measured by an RF Transceiver Device (2).

FIG. 5 illustrates an example of a travel time/process time (a “Delta time d”) between an event from an entry RF Transceiver Device (2a) and an event from an exit RF Transceiver Device (2b).

FIG. 6 illustrates an example of a process time (“Delta time d”) based on a first event from an entry RF Transceiver Device (2a) and a last event from an exit RF Transceiver Device (2b).

FIG. 7 illustrates a “Delta time d” associated with entry and exit events obtained based on adjacent Entry RF Transceiver Devices (2aa, tab) and adjacent Exit RF Transceiver Devices (2ba, 2bb).

FIGS. 8 and 9 illustrate discarding of staff-related events.

### DETAILED DESCRIPTION OF THE INVENTION

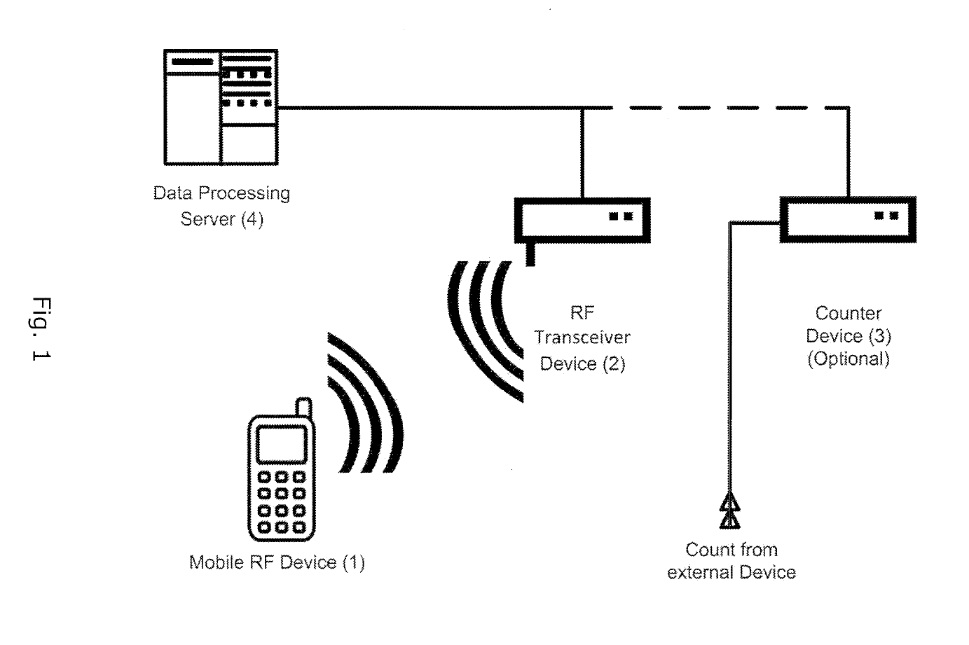

FIG. 1 illustrates a system that consists of a RF Transceiver Device (2), a Data Processing Server (4), a Mobile RF Device (1), and a Counter Device (3). The Mobile RF Device (1) could, for example, be a mobile phone or other RF enabled device carried by or attached to a moving entity to be monitored. The system can be used for monitoring dwell times. The RF Transceiver Device (2) is installed to measure the signal strength from the Mobile RF Device(s) (1) when the mobile device enters the area covered by the RF Transceiver Device (2). The optional Counter Device (3) can be used to collect information on how many passengers have passed through the covered area. When the Mobile RF Device (1) has been registered by RF Transceiver Device (2), one or more signals or “events” can be sent to the Data Processing Server (4) and the dwell time can be calculated. An “event” refers to a situation where a measurement from the RF Transceiver Device has fulfilled a certain condition, for instance that the RF Transceiver Device has identified the Mobile RF Device—an “Arrived” event; another type of event is the “Departed” event, which is an event that might represent that the RF Transceiver Device can no longer obtain an identity of the Mobile RF Device.

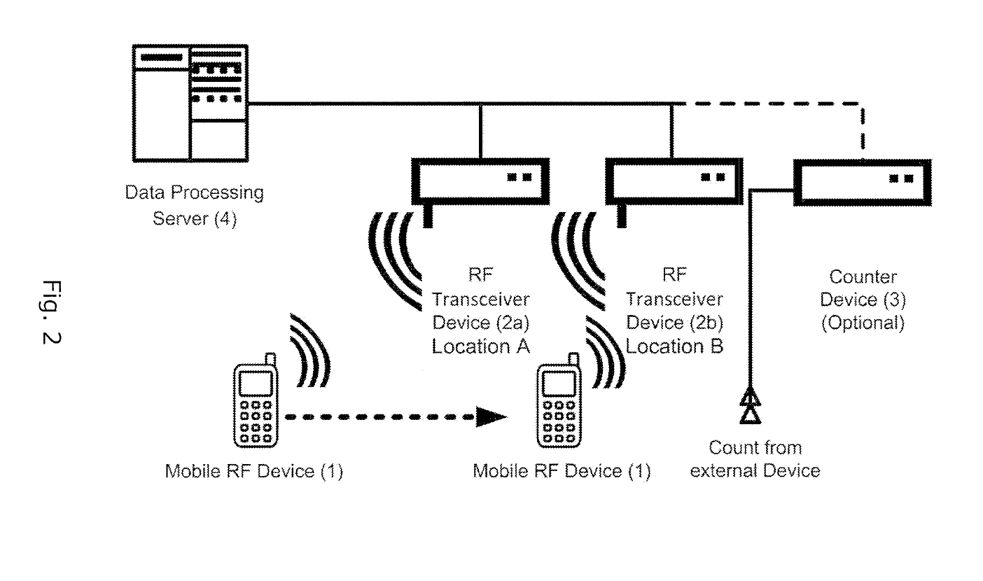

The system in FIG. 2 is able to calculate process times between two locations A and B. The system uses an RF Transceiver Device (2) at each of the locations and calculates the time between events from each RF Transceiver Devices (2a, 2b) generated based on signals from the Mobile RF Device (1). The optional Counter Device (3) collects information for instance for counting a number of entities that passes the physical entry or exit of the area. With this count information from the Counter Device (3) and the generated events from the RF Transceiver Devices (2), a forecasted process time can be calculated.

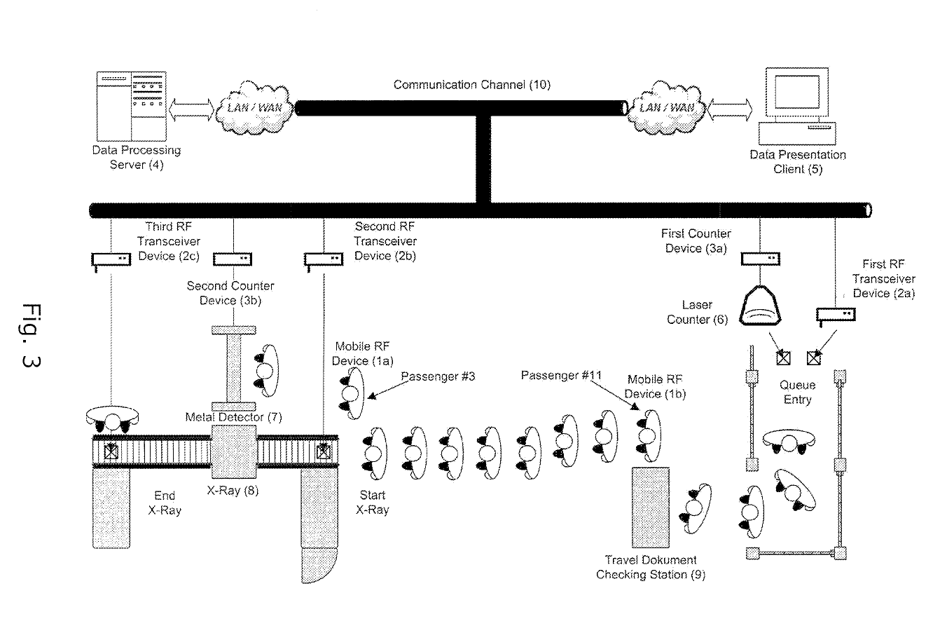

FIG. 3 shows an example of the system installed at a security check area in an airport. The system measures the time passengers have to wait in a queue from the point they enter the queue to the point that they reach the start of the X-Ray (8) equipment. It also measures the process time of the X-Ray procedure at the X-Ray (8) equipment and the number of passengers entering and exiting the queue. The information from each RF Transceiver device (2a, 2b, 2c) is sent to the Data Processing Server (4) over the Communication Channel (10). The queue time is hereafter determined by the Data Processing Server (4) calculating the time between events from the First RF Transceiver Device (2a) and the Second RF Transceiver Device (2b). Alternatively, the Data Processing Server receives raw data from the RF Transceiver and determines “events” itself by analyzing the data, for instance to find a time at which the RF Transceiver Device first obtains an identity from the transmitter. The X-Ray procedure time is determined by calculating the time between events from Second RF Transceiver Device (2b) and Third RF Transceiver Device (2c). In this specific installation the Data Processing Server (4) calculates the time between events from the RF Transceiver Devices (2a,2b,2c) defined in a set of configurable relation rules that define which events from which RF Transceiver Device (2a,2b,2c) or pair of RF Transceiver Devices (2a,2b,2c) that should generate i.e. a time difference between the occurrences of two specific events. Referring to FIG. 3 two relation rules could be defined for the monitored area in order to generate the queue time and the X-Ray procedure time respectively:
Relation rule 1: First RF Transceiver Device (2a) and Second RF Transceiver Device (2b) are used for determining the queue time
Relation rule 2: Second RF Transceiver Device (2b) and Third RF Transceiver Device (2c) are used for determining the X-Ray procedure time

The calculation of the time of for instance the X-ray procedure can begin as soon as the passenger with the Mobile RF Device 1a has generated the last event within a configurable timeout period, from the RF Transceiver Device (2c) configured in the relation rules as the “exit” RF Transceiver Device (2c). (Bidirectional measurement could for instance be configured by defining two opposite rules where the “entry” and “exit” RF Transceiver Device (2b, 2c) is used as “exit” and “entry” devices, respectively.) The result from the calculation, based on the relation rules, can be viewed on the Data Processing Server (4) or at a Data Presentation Client (5) where for example the manager for the monitored area could have a graphical overview of the process times for one or more monitored areas. The calculated data from the Data Processing Server (4) can also be transferred to an airport's operation management system for planning and optimizing purposes.

In addition to the RF Transceiver Devices (2a, 2b, 2c), two Counter devices (3a, 3b) can be installed to acquire data from the point where the passenger is entering the queue to the point where the passenger exits the queue. By a simple subtraction, the count of the passengers in the queue can be calculated. However in situations where the count sources are not 100% accurate the deviation of calculated number of passengers in queue will increase or decrease during the measurement period. By combining the events from the RF Transceiver Devices (2a, 2b, 2c) and the counts from the Counter Devices (3a, 3b) this deviation can be reduced.

Referring to FIG. 3 the First Counter Device (3a) acquires counts based on a laser (6) placed right next to the First RF Transceiver Device (2a) in order to count passengers entering the monitored area at the exact same point where the passenger passes the First RF Transceiver Device (2a). The entry counts can be used to measure the number of passengers that enters the queue after a passenger carrying a Mobile RF Device (1a, 1b) has passed the First RF Transceiver Device (2a). When the same Passenger reaches the Second RF Transceiver Device (2b) the system can calculate the accurate number of passengers queued up in the area. Combining the events from the RF Transceiver Devices (2a,2b) and the counts from the Counter Device (3a) is more precise than just subtracting exit and entry of passengers due to the fact that the deviation of the count from both the metal detector (7) and the laser (6) can vary during the day. The number of passengers in the monitored area can be used to calculate a forecasted queue time for a new passenger just entering the queue, simply by multiplying the calculated X-Ray (8) procedure time with the number of passenger waiting in queue. The X-Ray (8) procedure time can for example be determined from the calculation generated using Relation rule 2 as defined above. The X-Ray (8) procedure time can also be the time between two events from passengers exiting the queue by passing the Second RF Transceiver Device (2b) both carrying a Mobil RF Device (1a, 1b), divided by the numbers of passengers between the same two passengers, counted from the entry to the queue. Referring to FIG. 3 the numbers of passengers between “Passenger #3” and “Passenger #11” can be determined with the laser (6) connected to Counter Device (3a). In this case there are eight passengers between “Passenger #3” and “Passenger #11” (including “Passenger #11”). When “Passenger #11” is exiting the queue by passing the Second RF Transceiver Device (2b), the time between “Passenger #3” and “Passenger #11” can be calculated. Dividing this time with the counts, the queue process time for a single passenger, which virtually is the same as the X-Ray (8) procedure time, can be determined and a forecasted queue time can for example be updated and displayed every time a new passenger is entering the queue.

The RF Transceiver Device can contain one or more microprocessor(s) and one or more RF radio(s) for data processing and signal strength readings from Mobile RF Devices in range. It can also contain an appropriate interface for enabling communication with the Data Processing Server and can have a real time clock used for date time information in relation to the events the Mobile RF Device generates. The RF Transceiver Device could have a non-volatile or volatile memory buffer to store generated events for standalone operations or if the connection to the Data Processing Server should be disconnected.

The radio power level of the RF radio in the RF Transceiver Device can be configured to cover a certain area required for its physical position in the actual installation. The RF Transceiver Device can handle multiple Mobile RF Devices, which are distinct by a unique ID contained in the signal received from each Mobile RF Device. The RF Transceiver Device can be configured to generate different types of events for all Mobile RF Devices discovered and read in the area, monitored by the RF Transceiver Device. The tree event types could be called:
Arrived, representing that an RF transceiver has registered the mobile RF device;
Peaked, representing a peak (or local peak) measurement of the Mobile RF device by the RF transceiver device;
Departed, representing that the RF transceiver no longer can identify or detect a signal from the Mobile RF device.

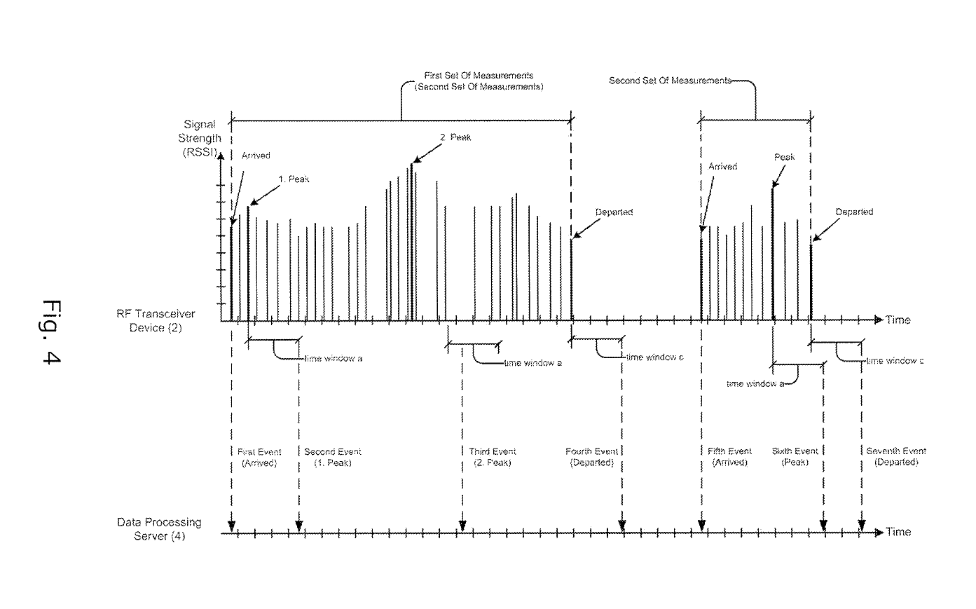

The event generation is based on signal strength readings from the specific Mobile RF Device read. FIG. 4 illustrates an example of the generation of two sets of events generated for a Mobile RF Device (e.g. 1a in FIG. 3). The x-axis “Time” represents the time in which period the measurement is carried out and the y-axis “Signal Strength (RSSI)” represents the signal strengths for the individual readings which are illustrated with vertical lines. The readings in this diagram only relate to readings from one Mobile RF Device (e.g. 1a in FIG. 3) to simplify the understanding, but could be from virtually an unlimited number of devices. To illustrate the event processing from the RF Transceiver Device (e.g. 2a, labeled “2” in FIG. 4) to the Data Processing Server (4) a second x-axis have been added named “Data Processing Server (4)”.

FIG. 4 also illustrates how these measurements can be considered sets of measurements, in particular a first set of measurements and a second set of measurements. In FIG. 4, the first set of measurements could be measurements from the First RF Transceiver Device (2a) and the second set of measurements could be measurements from the Second RF Transceiver Device (2b). A start time can be determined from the first set of measurements as described, and an end time can be determined from the second set of measurements. In a dwell time application, the first set of measurements can also act as second set of measurements. A start time could correspond to the “Arrived” measurement in the first set of measurements, where the First RF Transceiver Device (2a) first detects/identifies the Mobile RF Device. The end time could correspond to the “Departed” measurement in the first set of measurements, where the First RF Transceiver Device (2a) no longer detects/identifies the Mobile RF Device.

The vertical lines show the signal strength read from the Mobile RF Device and indirectly represents the distance between the RF Transceiver Device and Mobile RF Device. These signal strength readings are used to determine at which time the entity has been closest to the RF Transceiver Device (2) which can be taken to represent the time the object is passing the RF Transceiver Device (2).

When the Mobile RF Device (1a) is discovered for the first time, the RF Transceiver Device (2) can register the actual time, signal strength and the ID of the unique Mobile RF Device (1a) and sends an Arrived event (First Event) with the information to the Data Processing Server (4). The RF Transceiver Device can now measure the signal strength from the Mobile RF Device as long as the Mobile RF Device is in the area covered by the RF Transceiver Device. The RF Transceiver Device will capture the signal strength received from the Mobile RF Device every time it increases and store the information of the signal strength with the exact time of the specific increased reading. If the signal strength has not increased for a configurable “Time window a” a Peaked event will be dispatched to the Data Processing Server (4). The Peaked event (Second Event) can as well as the Arrived event (First Event) contain the unique ID from the Mobile RF Device (1), time information and signal strength value. Even though one Peaked event already has been sent to the Data Processing Server (4), the RF Transceiver Device could continue to measure the signal strength to detect if it increases further or if the Mobile RF Device gets out of the monitored area. If the signal strength is increasing further, a new signal strength value and time will be stored for the given Mobile RF Device. After a configurable timeout period “Time window b” a new Peaked event (Third Event) can be dispatched to the Data Processing Server (4). When the Mobile RF Device comes out of the RF Transceiver Device covered area for more than the time out period “Time window c” the RF Transceiver Device can deregister the Mobile RF device and send a departed event (Fourth Event) to the Data Processing Server (4). The Departed event can, like the Arrived event and the Peaked event, contain the unique ID from the Mobile RF Device, time and signal strength value information. If the Mobile RF Device comes back into the monitored area, covered by the RF Transceiver Device, the scenario starts from the beginning, with generating an Arrived, Peaked and Departed event. This is illustrated by the Fifth, Sixth and Seventh Event in FIG. 4.

With RF Transceiver Devices placed at the physical position defined as the entry and exit of the monitored area, such as at an entry and an exit of a mall, the Data Processing Server (4) could receive one set of events from each Mobile RF Device attached to an object, representing the time, and signal strength, each time an compatible object passes the RF Transceiver Device.

The time calculation process can be based on configurable device relations rules and adjacent device rules. The relation rules can basically define the event type to process (Arrived, Peaked, Departed), between two RF Transceiver devices. It can also define which specific event to process, should there be more events of the configured type from the same RF Transceiver Device. The relation rule could also contain a set of additional configurable time windows for adjusting the accuracy of the computations generated for each relation rules. Each device relation rule can generate an in-queue process time every time it is able to match an entry and an exit event generated for the same Mobile RF Device.

The adjacent device rules are used for defining the RF Transceiver Devices that are adjacent to each other. This is to prevent the process time to be calculated in parallel for the same object. For example if a mall or airport has one entry and two exits with a RF Transceiver Devices placed at each location, the two exit RF Transceiver Devices have to be configured as adjacent devices. This will prevent the calculation of two process times, should the object be read on both exit RF Transceiver Devices.

Where the entry to, and the exit from, for example a store or mall is physical the same, one or more additional RF Transceiver Device(s) can be placed inside the store. This can be used to measure the “dwell time” of a person visiting the store. It is determined whether the Mobile RF Device (1) has been inside the store or just passed by outside the entrance. In case Mobile RF Device just passed by and generated a set of events, these events could otherwise potentially be falsely matched and counted as actual visits. Having a related reading of the Mobile RF Device from inside the store the algorithm can correctly generate a valid dwell time for the visit. The Mobile RF Device could be carried by an individual customer or it can be attached to the shopping trolley or cart to get a complete picture of most customers dwell time. Adding a higher concentration of RF Transceiver Devices in a matrix pattern inside the store most often results in a higher resolution of customer movements as they traverse through the store.

The Data Processing Server (4) could contain the algorithm for calculating the time between the received events from one or more RF Transceiver Devices according to the device relation rules, a database containing events from the attached RF Transceiver Devices and Counter Devices (3), and appropriated interfaces and logic for communicating with external devices and computed data visualization application. The Data Processing Server (4) may also contain methods for configuring the RF Transceiver Devices and their internal functionality mode and operation which may vary depending on the RF Transceiver Device's location and environment.

The algorithm can calculate the time between events from related RF Transceiver Devices which has events from the same Mobile RF Device and optionally has logic for selectively excluding events from employees working in the monitored area. The related RF Transceiver Devices could be defined as Entry device and Exit device and represent the starting and ending point of the time calculation. The relation rules can contain a number of parameters defining the conditions for the time calculation. Each defined relation rule can generate calculated times based on events from RF Transceiver Device(s). Each generated time can for example contain information of the rule identifier, the unique Mobile RF Device ID and the calculated time.

In installation with multiple RF Transceiver Devices, multiple device relation rules may be configured. Some of these rules can be in parallel and could therefore result in calculation of two travel times from the same Mobile RF Device, even though the Mobile RF Device only has been through the monitored area once. The algorithm may therefore be able to distinguish events from RF Transceiver Device(s) defined as adjacent devices where, there is a possibility of the Mobile RF Devices generating events from more than one entry or exit RF Transceiver Devices.

The algorithm can generate matches, which represents the time between events of a given type from an entry and exit RF Transceiver Device defined by the device relation rules. The default matching event type could be defined as the “Peaked” event, as this represents the time where the Mobile RF Device attached to the moving object showed a peak measurement at the RF Transceiver Devices, which can be interpreted as a time at which the object was closest to the RF Transceiver Device. The event type can alternatively also be defined as “Arrived” and or “Departed” to generate travel times, depending on the particular scenario to be measured. The algorithm can be enabled to use a method for selecting the first, or the last event of the given event type to obtain best result. The device relation rule may for example be set up to calculate the time between the first “Peaked” event to the last “Peaked” event from a single installed RF Transceiver Device, or between the first “Arrived” event to the last “Departed” event from two different or the same RF Transceiver Device.

The criteria for a match may be defined as the “Exit” event, generated by the exit RF Transceiver Device must have a later generation time than the “Entry” event generated by the entry RF Transceiver Device. Based on this assumption the algorithm can therefore evaluate the Exit events related to the specific relation rule and hereafter look for an Entry event from the same unique Mobile RF Device. If an entry event is found, a match can be carried out and a delta time can be calculated.

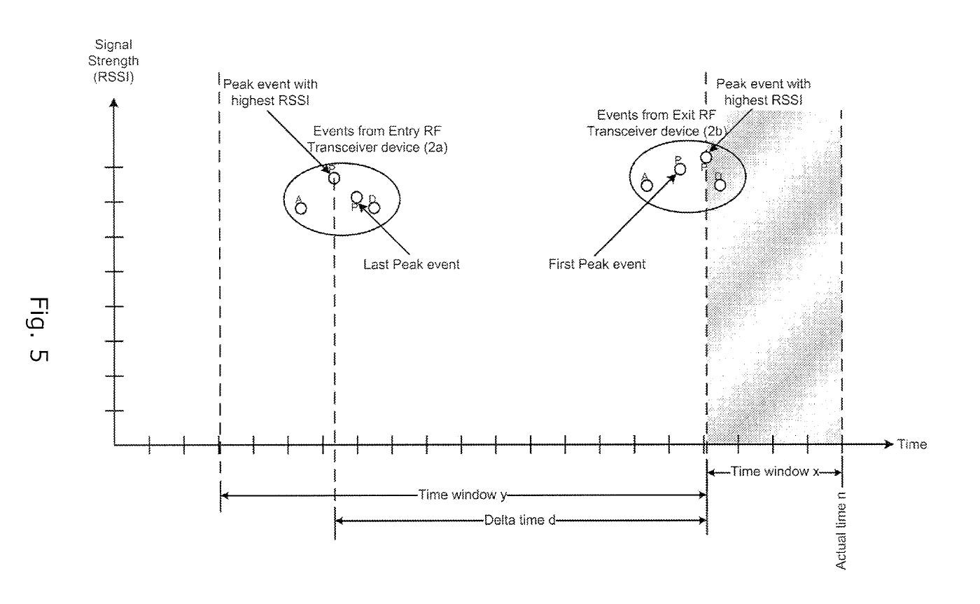

FIG. 5 shows an example of two sets of events from two RF Transceiver Devices (2a, 2b) defined in the relation rule as entry and exit respectively. Each RF Transceiver Device (2a, 2b) has generated four events from the same Mobile RF Device (e.g. Mobile RF Device 1a in FIG. 3), one Arrived (A), two Peaked (P) and one Departed (D). The x-axis “Time” represents the time and the y-axis “Signal Strength (RSSI)” represents the signal strength for the individual eight events. The “Time window x” can be added and configured to ensure that there is no more Exit events received for a certain time period from the exit device. A configurable “Time window y” can be added to limit the time window width the algorithm will search for an Entry event to match. The “Delta time d” represents the time span to be calculated.

Referring to FIG. 5, the algorithm will wait for the configurable “Time windows x” before it tries to match the Exit event with an Entry event. When the Exit event, in this case the “Peak event with highest RSSI”, from the exit RF Transceiver Device (2b), is older than the actual time, “Time n”, minus the configurable “Time window x”, the algorithm can search for an Entry event. The entry RF Transceiver Device (2a) generating the Entry event is defined in the device relation rule as entry device. The size of the time window that the algorithm uses in search for an Entry event is defined by the “Time window y”. “Time window y” can optimize the application run time, but also ensures that no Entry events from the same object from two separate measurements scenarios will be matched. For example, at a security check area in an airport, it is unlikely that the passenger is queued up more than once within one hour in the same monitored area. However the passenger could have been in the airport the day before generating an Entry event on the entry RF Transceiver Device (2a). In that case the “Time window y” is set to one hour.

A method to select First, Highest or Last event of the configured event type (Arrived, Peaked, Departed) can be added to make the algorithm match and calculate the time between multiple events. The selection method could be used for determine the very first time the Mobile RF Device (1a) is read, but still within the “Time window y”, and not just use the event with the highest signal strength. The selection method is used for dwell time measurement (time between first and last time an object was seen), but can also be used in special queue time measurement scenarios. For example in an security check area in an airport where the exit point of the queue is defined as the point where the passenger places their baggage on the conveyer, the queue time can be calculated using the first Peaked event. Using the first Peaked event can prevent using the highest Peaked event generated, should the passenger fail to go through the metal detector check and then return to the conveyer and make a new Peaked event with a higher RSSI value before he returns to the metal detector and makes another walk through.

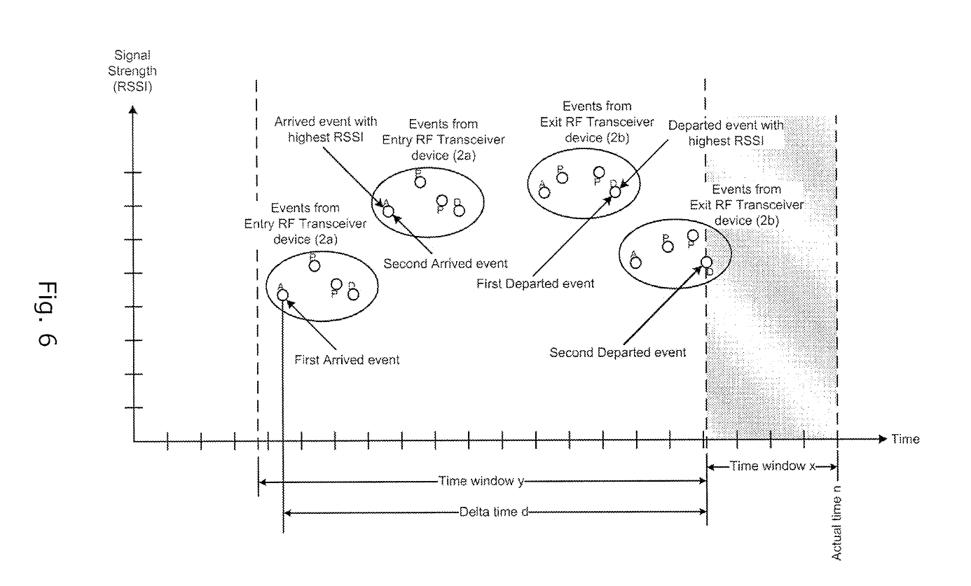

FIG. 6 shows an example where the algorithm, by the corresponding device relation rule is set to match and calculate the “Delta time d” between the first arrived event (marked “First Arrived Event”) from the entry RF Transceiver Device (2a) and the last departed event (marked “Second Departed Event”) from the Exit RF Transceiver Device (2b), even though the events do not represent the highest signal strength respectively.

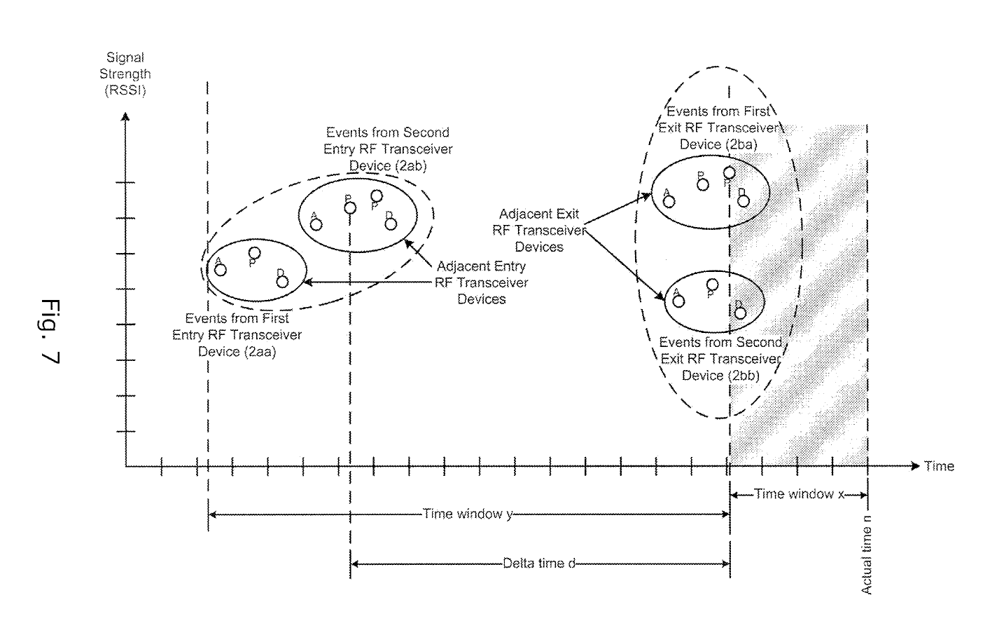

FIG. 7 illustrates events obtained from adjacent devices. This could be implemented to distinguish between multiple readings from Entry RF Transceiver Devices (2aa, tab) and Exit RF Transceiver Devices (2ba, 2bb) in a monitored area. For example in a security check area where there often is more than one entry and several exits to the monitored area, reading of the same Mobile RF Device from adjacent RF Transceiver Device is not unlikely. To measure the queue and X-Ray procedure time in such an area or similar, it is important that the Mobile RF Device is only measured once, in order to calculate the correct average times for the individual lanes, and the overall average times for the whole area. Once the adjacent RF Transceiver Devices have been defined, the algorithm can select which events to match among its adjacent entry or exit RF Transceiver Devices (2a, 2b) respectively.

FIG. 7 shows an example of events from two adjacent entry RF Transceiver Devices (2aa 2ab) and two adjacent exit RF Transceiver Devices (2ba, 2bb) installed in a monitored area with two physical entries and two physical exits. In this scenario the algorithm is by the device relation rule set to match the following two events:
1. the first Peaked event from the Entry RF Transceiver Device (2aa, 2ab) with the highest signal strength: “Second Entry RF Transceiver Device (2ab)”
2. the Peaked event with the highest signal strength from the Exit RF Transceiver Device (2ba, 2bb), “First Exit RF Transceiver device (2ba)”.

Since the “First Exit RF Transceiver Device (2ba)” and the “Second Exit RF Transceiver Device (2bb)” is adjacent, the algorithm will evaluate the Peaked (P) events from both of the RF Transceiver Devices (2ba, 2bb) and do the same for the “Adjacent Entry RF Transceiver Devices (2aa, 2ab)”.

This will result in a match and a calculation of the “Delta time d” between the first Peaked (P) event from the “Second Entry RF Transceiver Device (2ab)”, and the Peaked (P) event with the highest signal strength from the “First Exit RF Transceiver Device (2ba)”. The number of adjacent Entry RF Transceiver Devices (2aa, 2ab) and adjacent Exit RF Transceiver Devices (2ba, 2bb) can also be higher.

The algorithm can discard otherwise matching events which are generated by disqualifying object readings from a Mobile RF Device (1), carried by an employee or an object, not conforming to the defined flow pattern. This is in particular needed in queue areas where service personnel move around or within the queued customers. An object that is not following the defined qualifying flow pattern can be determined in the following two ways:
1. by checking if an entry event with a certain signal strength, exists after the last exit event that the algorithm is about to match.
2. by checking if an exit event, with a certain signal strength, exists before the entry event that the algorithm is about to match.
3. By checking if a Mobile RF Device (1), has been present in the covered area for more than a configurable time frame. The area can be covered by multiple RF Transceiver Devices.

The two first scenarios indicate that an object has been moving in the disqualifying direction. In this case, in the direction from the exit RF Transceiver Device to the entry RF Transceiver Device.

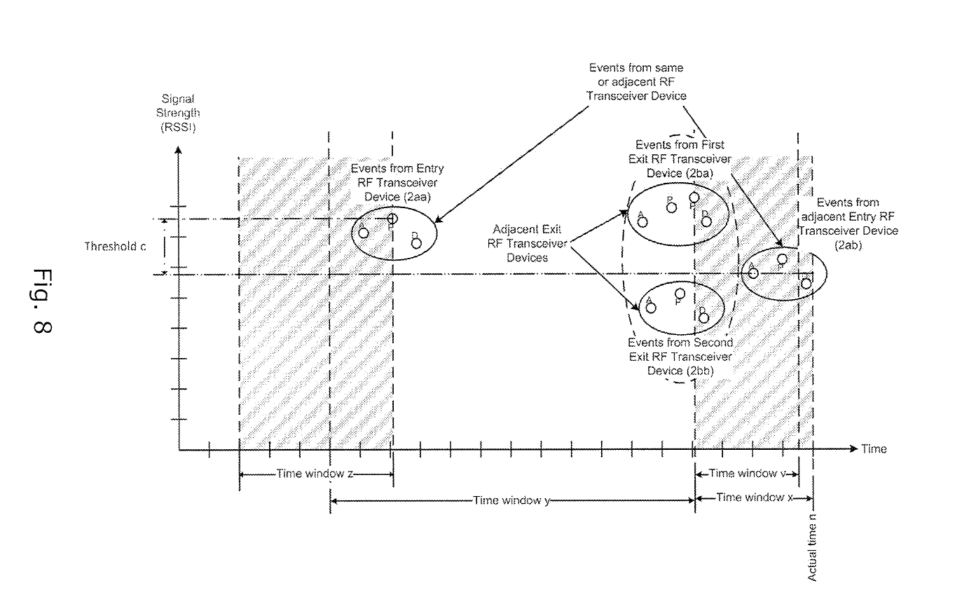

Referring to FIG. 8 the entry event after exit event verification can be accomplished by searching for an entry event in the configurable “Time window v”. The Entry event verification can be done both for events generated by the RF Transceiver Device (2aa) that the algorithm is about to match, and events from its adjacent RF Transceiver Devices (2ab).

If any entry event is found in the “Time window v” the algorithm can discard the match if the signal strength is higher than a configurable threshold. The threshold can be a fixed value or a percentage of the signal strength from the entry event, that the algorithm is about to match. Referring to FIG. 8 the “Threshold c” is shown as a fixed signal strength value subtracted from the signal strength of the Peaked (P) Entry event, of which the algorithm is about to match. As an entry event with a higher signal strength, than the entry event about to be matched, minus the “Threshold c” exists in the “Time window x”, this specific match will be discarded, as it indicates that the object is not conforming to the defined flow pattern.

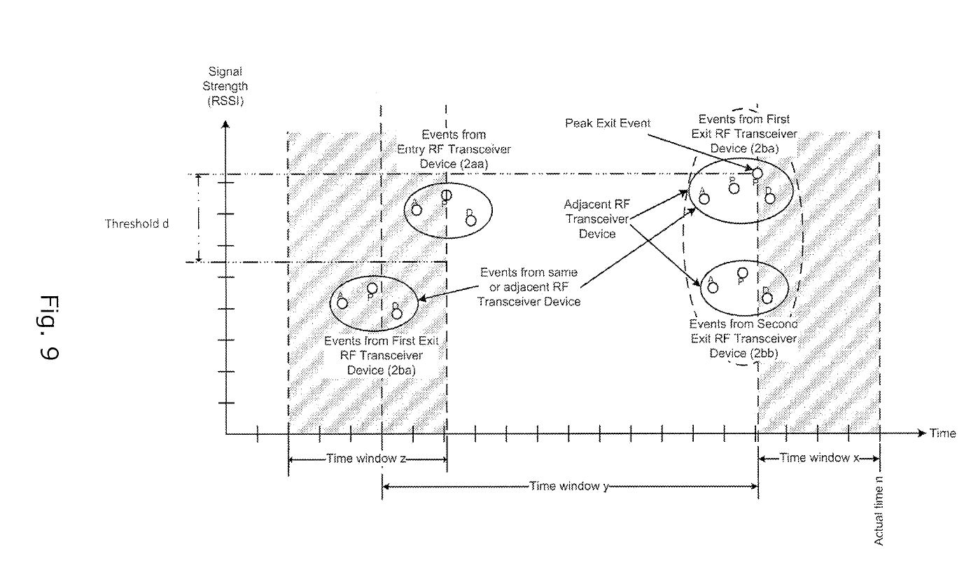

Referring to FIG. 9, the exit event before entry event verification is done by searching for an exit event in the configurable “Time window z” time span. The exit event verification can be done both for events from the RF Transceiver Device (2ba) that the algorithm is about to match events from, and for its adjacent devices. If any exit events are found in the “Time window z”, the algorithm can discard the match if the signal strength is higher than a configurable threshold, as it indicates that the object is not conforming to the defined flow pattern.

Referring to FIG. 9 the “Threshold d” is shown as a fixed signal strength value which is subtracted from the signal strength of the Peaked (P) Exit event, the algorithm is about to match. As an exit event is present in the “Time window z” the algorithm will look for the signal strength of the given event. In this case the exit event has lower signal strength than the exit event signal strength, about to be matched, minus the “Threshold d” and therefore this specific scenario will generate a match.

The algorithm may be configured to list Mobile RF Devices that repeatedly gets discarded from matching. This list can be used by the algorithm to verify if the Mobile RF Device exists in this list before it starts the matching procedure. The list can dynamically be reduced by the algorithm, by purging a Mobile RF Device from the list when it has not been observed within a configurable period of time.

Input to a list as described above can also be events from RF Transceiver Devices installed at special employee entrances, or special registration points supplied with a RF Transceiver Device. These RF Transceiver Device records employees or other objects Mobile RF Devices, when they enter the covered area.

An additional method of preventing invalid matched events to be generated is to have a cutoff thresholds window which simply discard computed delta times deviating from the configurable upper and lower thresholds. These two thresholds can either be a static or dynamic value, based on a percentage or a function of the deviation of the average delta time over a configurable time period.

1. A method of determining a travel time of an entity, the method comprising:
determining a start time based on a first set of measurements of signals emitted by a radio transmitter transported by the entity, the first set of measurements being obtained with a first signal receiver positioned at a first location;
determining an end time based on a second set of measurements of signals emitted by the radio transmitter, the second set of measurements being obtained with a second signal receiver positioned at a second location;
determining the travel time based on a difference between the start time and the end time; and
wherein the start time is a time corresponding to a peak value within the first set of measurements.

2. A method in accordance with claim 1, wherein the transmitter is a transceiver.

3. A method in accordance with claim 1, wherein the start time is a time at which the first receiver first detects a signal from the transmitter.

4. A method in accordance with claim 1, wherein the start time is a time at which the first receiver first obtains a transmitter identity from the transmitter.

5. A method in accordance with claim 1, wherein the start time is a time at which the first receiver can no longer obtain a transmitter identity from the transmitter.

6. (canceled)

7. A method in accordance with claim 1, wherein the start time is a time at which the first receiver can no longer detect a signal from the transmitter.

8. A method in accordance with claim 1, wherein the end time is a time at which the second receiver first detects a signal from the transmitter.

9. A method in accordance with claim 1, wherein the end time is a time at which the second receiver first obtains a transmitter identity from the transmitter.

10. A method in accordance with claim 1, wherein the end time is a time at which the second receiver can no longer obtain a transmitter identity from the transmitter.

11. A method in accordance with claim 1, wherein the end time is a time corresponding to a peak value within the second set of measurements.

12. A method in accordance with claim 1, wherein the end time is a time at which the second receiver can no longer detect a signal from the transmitter.

13. A method of determining a dwell time of an entity within a first area, comprising:
determining a start time based on a first set of measurements of signals emitted by a radio transmitter transported by the entity, the first set of measurements being obtained with a first signal receiver positioned at a first location;
determining an end time based on a second set of measurements of signals emitted by the radio transmitter, the second set of measurements being obtained with the first signal receiver or a second signal receiver positioned at a second location;
determining the dwell time based on a difference between the start time and the end time; and
wherein the start time is a time corresponding to a peak value within the first set of measurements.

14. A method in accordance with claim 13, further comprising, when a second signal receiver is used, detecting a presence of the entity in a vicinity of the second location using the second signal receiver.

15. A method in accordance with claim 13, wherein the transmitter is a transceiver.

16. A method in accordance with claim 13, wherein the start time is a time at which the first receiver first detects a signal from the transmitter.

17. A method in accordance with claim 13, wherein the start time is a time at which the first receiver first obtains a transmitter identity from the transmitter.

18. A method in accordance with claim 13, wherein the end time is a time at which the first receiver can no longer detect a signal from the transmitter.

19. A method in accordance with claim 13, wherein the end time is a time at which the first receiver can no longer obtain a transmitter identity from the transmitter.

20.-21. (canceled)

22. A computer system configured to:
receive a first set of measurements representing signals emitted by a radio transmitter transported by an entity, and determining a start time based on the first set of measurements;
receive a second set of measurements representing signals emitted by a radio transmitter transported by the entity, and determining an end time based on the second set of measurements;
determining a difference between the end time and the start time, wherein the start time is a time corresponding to a peak value within the first set of measurements.

23. A computer system in accordance with claim 22, wherein first set of measurements are obtained with a first signal receiver positioned at a first location, and the second set of measurements are obtained with a second signal receiver positioned at a second location.

24.-39. (canceled)
